(19) United States
(12) Patent Application Publication
(10) Pub. No.: US 2026/0260328 A1
(43) Pub. Date: Sep. 3, 2026

(54) ADAPTIVE AI SYSTEM FOR PROPERTY-BASED STRUCTURAL CONDITION ASSESSMENT, RECOMMENDATION SCORING, AND PERSONALIZED ENGAGEMENT ARTIFACT GENERATION

(71) Applicant: Kevin Ramesh Kabaria, Richlands, VA (US)

(72) Inventor: Kevin Ramesh Kabaria, Richlands, VA (US)

(21) Appl. No.: 19/546,437

(22) Filed: Feb. 23, 2026

Related U.S. Application Data
(60) Provisional application No. 63/762,022, filed on Feb. 23, 2025.

(51) Int. Cl. G06T 7/00; G06T 3/4046; G06T 3/4053; G06T 5/60; G06T 5/70; G06V 10/26; G06V 10/778; G06V 20/10; G06V 20/13

(52) U.S. Cl. CPC G06T 7/0002; G06T 3/4046; G06T 3/4053; G06T 5/60; G06T 5/70; G06V 10/26; G06V 10/7788; G06V 20/13; G06V 20/176; G06T 2200/24; G06T 2207/10032; G06T 2207/20084

(57) ABSTRACT

A system, method, and non-transitory computer-readable storage medium for automated property structural condition assessment and property-specific engagement artifact generation. The system receives, from multiple data sources, aerial or satellite imagery depicting a plurality of structures, weather event data, and building metadata. For each of at least a subset of the structures, the system applies one or more image enhancement models to produce enhanced imagery having improved signal quality, applies one or more feature extraction models to generate structural condition indicators with associated confidence values, and computes a recommendation score by fusing the structural condition indicators with at least the weather event data and building metadata according to a weighting scheme. For structures having recommendation scores satisfying a selection criterion, the system automatically generates a property-specific engagement artifact that includes an annotated visual representation and the recommendation score.

### CROSS-REFERENCE TO RELATED APPLICATIONS

This application claims the benefit of U.S. Provisional Patent Application No. 63/762,022, filed Feb. 23, 2025, the entire disclosure of which is incorporated herein by reference.

### TECHNICAL FIELD

The present disclosure relates generally to computer-implemented systems and methods for automated assessment of physical properties using imagery and machine learning, and more particularly to systems that fuse imagery-derived structural indicators with weather event data and building metadata to compute per-property recommendation scores and automatically generate property-specific engagement artifacts. The imagery may include aerial imagery, satellite imagery, drone imagery, or other imagery capturing physical structures.

### BACKGROUND OF THE INVENTION

Property owners, service providers, and facility managers face ongoing challenges in identifying physical structures that may require inspection, maintenance, or repair. In some conventional approaches, identifying candidate properties for service involves labor-intensive manual inspection processes such as driving through neighborhoods, visually assessing structures from the ground, or relying on property owner self-reporting. These conventional approaches may be time-consuming, geographically limited, and inconsistently applied.

Some existing systems have attempted to use aerial or satellite imagery to assess aspects of physical structures. However, such systems may focus primarily on dimensional measurement (e.g., roof area, pitch) or insurance risk estimation without providing an integrated assessment that accounts for multiple condition types, weather exposure history, and building-specific metadata. Additionally, such systems may rely on purpose-captured high-resolution imagery, which can be cost-prohibitive for large-scale geographic coverage.

Mass-market commodity aerial and satellite imagery, while available at broad geographic scale and lower cost, presents technical challenges for structural condition assessment. Such imagery may exhibit lower spatial resolution, sensor noise, atmospheric artifacts, occlusions from vegetation or shadows, and inconsistent capture conditions. These characteristics can reduce the accuracy and reliability of automated analysis systems that were designed for higher-quality input imagery.

Furthermore, some existing systems may generate analysis results but lack mechanisms for automatically translating those results into actionable, property-specific outputs that a service provider can use in field operations. A gap may exist between identifying that a structure has a particular condition and providing a service provider with the specific materials, data presentations, and communication tools needed to engage with the property owner about that condition.

Additionally, in some existing systems, the features extracted from imagery are designed for a fixed intermediate representation (e.g., a generic condition score) that may not align with the specific downstream needs of a particular service provider or property stakeholder. Such systems may lack the ability to adjust or fine-tune the feature extraction and scoring pipeline based on the actual end-state recommendation that the service provider requires, resulting in a disconnect between the analytical outputs and the actionable recommendations needed for different use cases such as maintenance prioritization, financial planning, energy efficiency assessment, or resource allocation.

Accordingly, there is a need for computer-implemented systems and methods that can extract reliable structural assessments from mass-market commodity imagery, fuse those assessments with heterogeneous contextual data sources, compute property-specific recommendation scores tailored to the downstream needs of service providers and property stakeholders, and automatically generate engagement artifacts tailored to individual properties and service provider preferences. There is a further need for such systems to support end-to-end optimization, where the recommendation scoring objective can inform and refine the upstream feature extraction and image processing operations.

### SUMMARY OF THE INVENTION

In one aspect, the present disclosure provides a system for automated property structural condition assessment and property-specific engagement artifact generation. The system includes one or more processors and one or more non-transitory computer-readable storage media storing instructions that, when executed by the one or more processors, cause the system to: receive, from a plurality of data sources, aerial or satellite imagery depicting a plurality of structures within a geographic region, weather event data characterizing one or more weather events affecting the geographic region, and building metadata describing attributes of the plurality of structures; for each respective structure of at least a subset of the plurality of structures, apply one or more image enhancement models to produce enhanced imagery having improved signal quality, apply one or more feature extraction models to the enhanced imagery to generate structural condition indicators with associated confidence values, and compute a recommendation score by fusing the structural condition indicators with at least the weather event data and building metadata according to a weighting scheme; and for structures having recommendation scores satisfying a selection criterion, automatically generate a property-specific engagement artifact comprising at least an annotated visual representation of the respective structure and the respective recommendation score.

In another aspect, the present disclosure provides a computer-implemented method for assessing structural conditions of a plurality of structures and generating property-specific engagement artifacts.

In yet another aspect, the present disclosure provides a non-transitory computer-readable storage medium storing instructions for performing the above operations.

In some embodiments, the image enhancement models comprise a generative adversarial network trained to perform super-resolution processing or denoising on the aerial or satellite imagery. In some embodiments, a diffusion-based refinement model conditioned on at least one environmental parameter may be applied to refine portions of the enhanced imagery.

In some embodiments, an instance segmentation model identifies individual roof regions within the imagery, and the feature extraction models are applied to the individual roof regions. The instance segmentation model may be trained on a training dataset comprising both manually annotated imagery and synthetically generated imagery.

In some embodiments, the recommendation score is computed by applying both a machine-learned scoring model and a rule-based scoring model and combining their outputs. The weighting scheme may be configurable by a user through a user interface.

In some embodiments, the system compares feature representations from imagery captured at different times to generate temporal change indicators that are incorporated into the recommendation score.

In some embodiments, the property-specific engagement artifact comprises a machine-readable code linking to a hosted digital portal. In some embodiments, structures having confidence values below a review threshold are routed to a human review queue, and reviewer annotations are incorporated into model retraining datasets.

### BRIEF DESCRIPTION OF THE DRAWINGS

FIG. 1 is a block diagram illustrating a system architecture overview of a structural condition assessment and engagement artifact generation system, according to some embodiments.

FIG. 2 is a flowchart illustrating a data ingestion pipeline for acquiring and normalizing multi-source data, according to some embodiments.

FIG. 3 is a block diagram illustrating a multi-model AI analysis pipeline for processing imagery of a physical structure, according to some embodiments.

FIG. 4 is a diagram illustrating instance segmentation and roof region extraction from aerial imagery, according to some embodiments.

FIG. 5 is a block diagram illustrating an image enhancement pipeline comprising one or more independently optional enhancement stages, including a generative adversarial network stage and a diffusion-based refinement stage, according to some embodiments. Either stage may be applied alone, both may be applied in sequence, or the enhancement pipeline may comprise other model-based enhancement approaches.

FIG. 6 is a diagram illustrating feature extraction and structural condition detection using a model ensemble, according to some embodiments.

FIG. 7 is a block diagram illustrating a temporal comparison architecture for comparing imagery captured at different times, according to some embodiments.

FIG. 8 is a diagram illustrating recommendation score computation via multimodal data fusion, according to some embodiments.

FIG. 9 is a block diagram illustrating engagement artifact generation for multiple artifact types, according to some embodiments.

FIG. 10 is a flowchart illustrating a human review and active learning loop, according to some embodiments.

FIG. 11 is a flowchart illustrating a continuous monitoring workflow with trigger-based re-assessment, according to some embodiments.

FIG. 12 is a sequence diagram illustrating an end-to-end operational flow from user request to artifact delivery, according to some embodiments.

FIG. 13 is a diagram illustrating geographic region processing and batch operations, according to some embodiments.

FIG. 14 is a diagram illustrating an example homeowner-facing engagement portal, according to some embodiments.

FIG. 15 is a block diagram illustrating deployment configurations including cloud, on-premise, hybrid, and edge computing, according to some embodiments.

FIG. 16 is a block diagram illustrating a computing system environment suitable for implementing the described system, according to some embodiments.

### DETAILED DESCRIPTION OF THE INVENTION

### General

The following detailed description is provided to enable any person skilled in the art to make and use the disclosed embodiments. Various modifications will remain apparent to those skilled in the art. The general principles defined herein may be applied to other embodiments and applications without departing from the spirit and scope of the disclosure. The present disclosure is not intended to be limited to the embodiments shown but is to be accorded the widest scope consistent with the principles and features disclosed herein.

As used herein, the term “structure” refers to a physical building, edifice, construction, or infrastructure element (e.g., a residential house, a commercial building, a warehouse, a multi-unit dwelling, a detached garage, a bridge, a road surface, a paved lot, or similar physical structure or infrastructure) that may be depicted in imagery and assessed for physical characteristics. As used herein, the term “plurality” means more than one.

As used herein, the term “structural condition indicator” refers to a data element generated by a computational model that characterizes a detected physical attribute or condition of a structure or a component thereof (e.g., a roof), including at least an attribute or condition type identifier and an associated confidence value, and optionally including a severity value, a measurement value, and spatial coordinates indicating a location of the detected attribute or condition within the imagery. Structural condition indicators may include, without limitation, indicators of physical damage, material type, material age, structural geometry, component dimensions, manufacturer or brand identification, surface composition, and other physically observable characteristics.

As used herein, the term “recommendation score” refers to a computed value derived by fusing one or more structural condition indicators with one or more additional data inputs (e.g., weather event data, building metadata) according to a weighting scheme. The recommendation score represents a property-specific assessment output tailored to the needs of a service provider or property stakeholder. The recommendation score is not limited to representing inspection priority; it may represent any downstream assessment objective such as maintenance priority, intervention value, service suitability, energy efficiency potential, financial planning priority, or other property-relevant recommendation. The recommendation score may be a scalar numerical value, a multi-dimensional vector, a categorical classification, or a combination thereof.

As used herein, the term “engagement artifact” refers to a computer-generated output associated with a specific assessed structure, comprising at least an annotated visual representation of the structure and an associated recommendation score, and optionally comprising one or more of: a hosted digital portal, a machine-readable code (e.g., a QR code or barcode), a printable document, recommended actions, tailored improvement recommendations, confidence intervals, explanatory content in human-readable format, or an interface to a conversational agent.

As used herein, the term “enhanced imagery” refers to imagery that has been processed by one or more image enhancement models to improve at least one quality characteristic (e.g., spatial resolution, noise level, occlusion artifacts, shadow artifacts, contrast) relative to the originally received imagery.

As used herein, the term “imagery” or “aerial or satellite imagery,” unless otherwise specified, refers broadly to imagery of physical structures or geographic regions captured by any imaging platform, including but not limited to satellites, manned aircraft, unmanned aerial vehicles (drones), ground-based cameras, or handheld devices. The techniques described herein provide particular utility when applied to aerial or satellite imagery, but are not limited to imagery from any single platform or capture method.

As used herein, the term “commodity imagery” refers to imagery that is commercially available from one or more mass-market imagery providers, as distinguished from purpose-captured imagery acquired specifically for a particular analysis task (e.g., purpose-flown drone imagery for a single property).

### System Architecture Overview

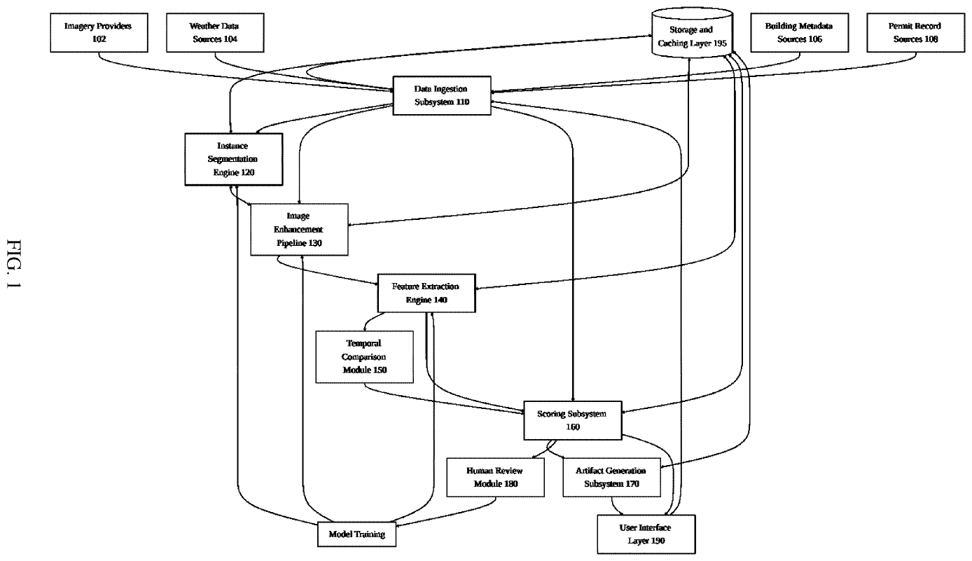

FIG. 1 illustrates a system architecture overview of a structural condition assessment and engagement artifact generation system 100, according to some embodiments. The system 100 includes a data ingestion subsystem 110, an instance segmentation engine 120, an image enhancement pipeline 130, a feature extraction engine 140, a temporal comparison module 150, a scoring subsystem 160, an artifact generation subsystem 170, a human review module 180, a user interface layer 190, and a storage and caching layer 195.

The data ingestion subsystem 110 is configured to receive data from a plurality of external data sources, including one or more imagery providers 102 (providing aerial or satellite imagery), one or more weather data sources 104 (providing weather event data), one or more building metadata sources 106 (providing building attributes and property records), and one or more permit record sources 108 (providing building permit data). In some embodiments, the data ingestion subsystem 110 normalizes, geocodes, and validates incoming data before storing it in the storage and caching layer 195 and providing it to downstream processing components.

The instance segmentation engine 120 applies one or more instance segmentation models to identify individual structural regions (e.g., roof regions) within the imagery. For each detected structural region, the instance segmentation engine 120 produces a segmentation mask, bounding coordinates, a class label, and a confidence value. In some embodiments, the instance segmentation engine 120 receives imagery directly from the data ingestion subsystem 110 and segments structural regions before image enhancement. In some embodiments, the instance segmentation engine 120 receives imagery that has already been processed by the image enhancement pipeline 130, such that enhancement precedes segmentation. In some embodiments, instance segmentation is applied both before and after image enhancement (e.g., a first segmentation pass on raw imagery to identify regions of interest, followed by enhancement of those regions, followed optionally by a refined segmentation pass on the enhanced imagery). The ordering of segmentation and enhancement stages is configurable and may vary by embodiment.

The image enhancement pipeline 130 applies one or more image enhancement models to produce enhanced imagery having improved signal quality relative to the originally received imagery. In some embodiments, the image enhancement pipeline 130 receives segmented structural regions from the instance segmentation engine 120. In some embodiments, the image enhancement pipeline 130 receives raw imagery from the data ingestion subsystem 110 before segmentation. The image enhancement pipeline 130 may include one or both of: a generative adversarial network (GAN) for super-resolution processing and/or denoising, and a diffusion-based refinement model for further quality improvement. Each of the GAN and the diffusion-based refinement model is independently optional; either may be applied alone, both may be applied in sequence, or the enhancement pipeline may comprise other model-based enhancement approaches. In some embodiments, the diffusion-based refinement model is conditioned on data from the data ingestion subsystem 110, such as building metadata or weather event data associated with the structure being processed.

The feature extraction engine 140 receives enhanced imagery from the image enhancement pipeline 130 and applies one or more feature extraction models (e.g., convolutional neural networks, vision transformers, or combinations thereof) to generate, for each assessed structure, a set of structural condition indicators, each associated with a confidence value. The structural condition indicators may characterize physical damage conditions, material type, structural geometry, component dimensions, surface composition, manufacturer or brand identification, and other physically observable attributes of the structure. In some embodiments, the feature extraction engine 140 additionally receives contextual data from the data ingestion subsystem 110 (e.g., building metadata, weather data) as supplementary inputs to the feature extraction models.

The temporal comparison module 150 is configured to, when imagery of a given structure captured at two or more different times is available, compare feature representations extracted from the imagery at different times to generate temporal change indicators such as detected changes, relative condition progression estimates, or temporal validation signals.

The scoring subsystem 160 receives structural condition indicators from the feature extraction engine 140, optional temporal change indicators from the temporal comparison module 150, weather event data and building metadata from the data ingestion subsystem 110, and computes a per-structure recommendation score by fusing these inputs according to a configurable weighting scheme. In some embodiments, the scoring subsystem 160 includes both a machine-learned scoring model and a rule-based scoring model.

The artifact generation subsystem 170 receives recommendation scores and associated data from the scoring subsystem 160 and generates property-specific engagement artifacts for structures satisfying a selection criterion (e.g., a recommendation score exceeding a threshold). The engagement artifacts may include annotated visual representations, hosted digital portals, machine-readable codes, printable documents, and recommended actions.

The human review module 180 receives structures flagged by the scoring subsystem 160 or the feature extraction engine 140 based on low confidence values or other flagging criteria, presents them to human reviewers through a review interface, captures reviewer annotations, and provides those annotations as additional training data for model improvement.

The user interface layer 190 provides web-based and/or mobile interfaces for user interaction, including geographic region selection, parameter configuration, result viewing, and artifact access. The storage and caching layer 195 provides persistent and temporary storage for imagery, intermediate processing outputs, scores, artifacts, model weights, and cached computations.

In some embodiments, the system 100 supports end-to-end optimization in which the recommendation score objective or a downstream engagement outcome signal is used to refine the operation of one or more upstream processing components, including the image enhancement pipeline 130 and/or the feature extraction engine 140. For example, a gradient or optimization signal derived from the recommendation score may be propagated back through the scoring subsystem 160 to the feature extraction engine 140 and optionally to the image enhancement pipeline 130, enabling the upstream models to be fine-tuned to produce features and enhancements that are specifically optimized for the downstream recommendation objective rather than for a generic intermediate representation. This end-to-end fine-tunability enables the system 100 to adapt the entire processing pipeline to the specific needs of a given service provider, property stakeholder, or use case, such that different recommendation objectives (e.g., maintenance prioritization versus energy efficiency assessment versus financial planning) can each drive specialized feature extraction behavior from the same underlying imagery and contextual data inputs. In some embodiments, the end-to-end optimization is performed during a fine-tuning phase using labeled outcome data (e.g., confirmed service outcomes, inspection results, or user feedback signals), and the fine-tuned model weights are deployed for subsequent inference operations. The end-to-end optimization does not require that the entire pipeline be differentiable in a single computational graph; in some embodiments, the optimization is performed in a staged manner, in which the upstream models (e.g., image enhancement and feature extraction) are pre-trained independently, and a subsequent fine-tuning phase uses recommendation outcome labels to adjust the weights of one or more upstream models in sequence, propagating the recommendation objective back through the pipeline in discrete stages. In some embodiments, the fine-tuning phase uses in-context learning or adapter modules to efficiently adapt pre-trained model weights to a new recommendation objective without full retraining.

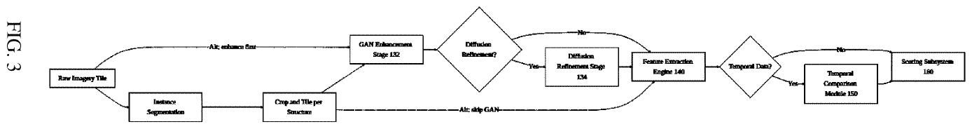

FIG. 3 illustrates a multi-model AI analysis pipeline for processing imagery of a physical structure, according to some embodiments. The pipeline depicted in FIG. 3 shows the sequential processing stages described in the following sections, including instance segmentation, image enhancement, feature extraction, temporal comparison, and scoring. The specific ordering, components, and optional stages depicted in FIG. 3 are illustrative and do not preclude other configurations or orderings as described herein.

### Data Ingestion Subsystem

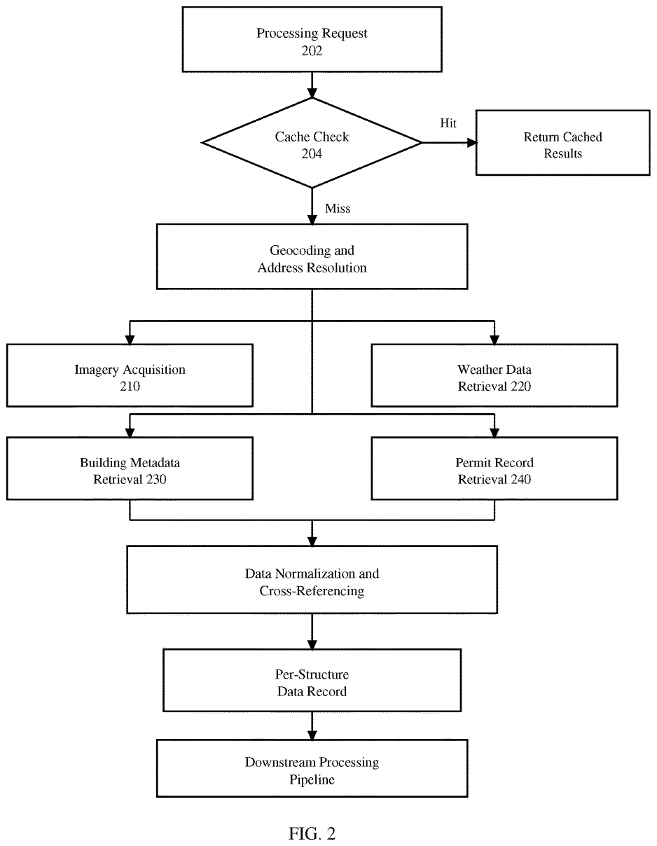

FIG. 2 illustrates a data ingestion pipeline 200, according to some embodiments. Upon receiving a processing request 202 (e.g., a user selection of a geographic region, a batch address list, or a single property address), the data ingestion subsystem 110 first performs a cache check 204 against the storage and caching layer 195 to determine whether previously computed results exist for the requested structures.

For structures not found in cache (cache misses), the data ingestion subsystem 110 resolves each target structure to geographic coordinates using one or more geocoding services (e.g., address-to-coordinate resolution, parcel centroid lookup, or proprietary geocoding) if geographic coordinates are not already associated with the target structure. The resolved geographic coordinates enable subsequent imagery acquisition and weather geographic matching. Following geocoding, the data ingestion subsystem 110 initiates parallel data acquisition from multiple sources. In some embodiments, the parallel acquisition includes: imagery acquisition 210 from one or more configured imagery providers, weather data retrieval 220 from one or more weather data sources, building metadata retrieval 230 from one or more property data sources, and permit record retrieval 240 from one or more permit data sources.

The imagery acquisition 210 acquires imagery tiles covering the geographic locations of the target structures. In some embodiments, the imagery comprises aerial imagery captured by manned aircraft, satellite imagery, drone imagery captured by unmanned aerial vehicles, or ground-level imagery captured by cameras or handheld devices. In some embodiments, the imagery is acquired from one or more imagery provider APIs; in some embodiments, the imagery is loaded from a local or remote file store or data repository containing previously captured imagery. In some embodiments, the imagery is acquired in one or more standard formats (e.g., GeoTIFF, JPEG, PNG) at available spatial resolutions. The system 100 is configured to operate on imagery spanning a range of spatial resolutions from sub-centimeter per pixel (e.g., drone or close-range capture) to approximately 20 centimeters or more per pixel ground sampling distance (GSD), and may process imagery at even lower resolutions when combined with enhancement. In some embodiments, the system 100 is further configured to operate on imagery captured from nadir (directly overhead), oblique, or angled viewing geometries, and on imagery in one or more spectral bands including visible light (RGB), visible light with alpha channel (RGBA), near-infrared (NIR), infrared (IR), multispectral, hyperspectral, synthetic aperture radar (SAR), or combinations thereof. The techniques described herein provide particular utility when applied to mass-market commodity aerial or satellite imagery, but are applicable to imagery from any capture platform.

The weather data retrieval 220 acquires weather event data characterizing weather phenomena that have affected or may affect the geographic region. In some embodiments, the weather event data includes records of discrete weather events such as hail events, wind events, heavy precipitation events, temperature cycling events (freeze-thaw cycles), ice storms, or combinations thereof. Each weather event record may include event type, severity metrics (e.g., maximum hail diameter, maximum wind speed, cumulative precipitation), spatial extent information (e.g., storm polygon boundaries, event centroid coordinates), temporal extent (e.g., event start and end times), and data source provenance. In some embodiments, the weather event data additionally or alternatively includes continuous time-series weather data characterizing ongoing environmental conditions such as temperature, precipitation, UV exposure, humidity, and barometric pressure over time, which may be relevant for assessing cumulative environmental exposure effects on structures. The weather data may be obtained from public sources (e.g., government meteorological agencies, government aviation agencies), private weather data providers, or proprietary weather computation models.

In some embodiments, the system 100 includes a weather computation module that computes hyper-local weather exposure metrics for individual structures using one or more of: interpolation from nearby weather station observations, storm polygon intersection with structure coordinates, grid-based weather data sampling at the structure's geographic location, or three-dimensional trajectory modeling for specific weather phenomena (e.g., modeling hail stone trajectories accounting for wind patterns and elevation). The weather computation module may use one or more geographic matching approaches including point-based queries using structure centroid coordinates, buffered point queries, parcel polygon intersection, roof footprint intersection, or hexagonal tiling system (e.g., H3) cell membership.

The building metadata retrieval 230 acquires structured data describing attributes of the target structures. In some embodiments, the building metadata includes one or more of: construction date or estimated age, primary structural material (e.g., roof material type), structure area or dimensions, parcel identification, occupancy type (e.g., residential, commercial, multi-family), assessed property value, number of stories, and geographic coordinates. The building metadata may be obtained from public property tax assessment databases, parcel record databases, property data aggregation services, or combinations thereof.

The permit record retrieval 240 acquires building permit data associated with the target structures. In some embodiments, the system 100 processes permit records to derive permit-based condition signals. A permit-based condition signal may indicate one or more of: a prior repair event (suggesting previous damage), a damage-related permit filing, a construction milestone (e.g., new roof installation date), or an active construction activity. In some embodiments, permit records are normalized to a common schema including at least an address, permit type, filing date, and a work description field. In some embodiments, the system 100 applies a rule-based extraction process or a machine-learned classification model to permit work descriptions to identify roof-relevant permit signals and assign a confidence value to each extracted signal.

Following acquisition, the acquired data from each data source undergoes normalization and cross-referencing. In some embodiments, acquired building metadata and permit records are linked to the target structures using the geographic coordinates resolved during the geocoding step described in paragraph [0054], property identification numbers, or address matching. In some embodiments, parcel boundaries are resolved from property identification numbers or geographic coordinates to enable spatial association of acquired data with individual structures. The normalized data for each target structure is assembled into a per-structure data record that is stored in the storage and caching layer 195 and passed to downstream processing components.

### Instance Segmentation and Roof Region Extraction

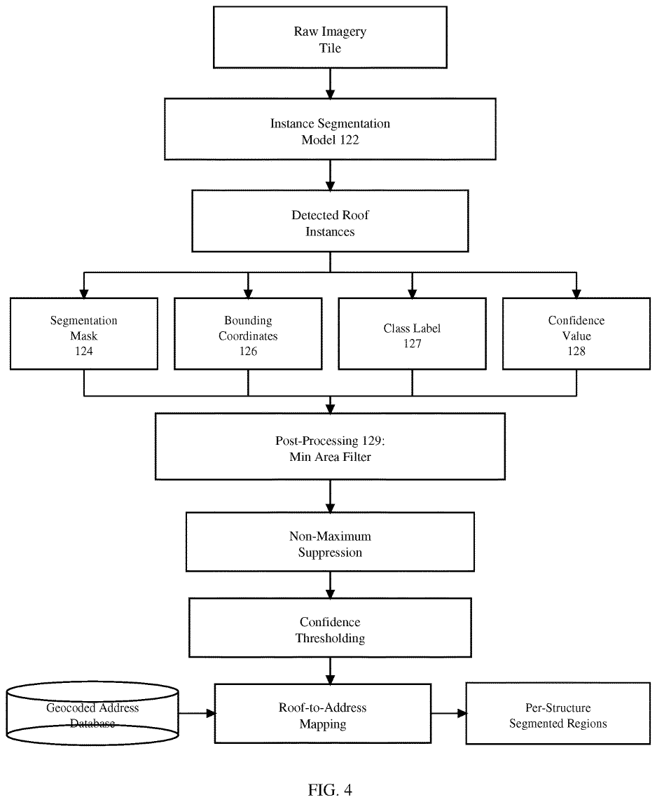

FIG. 4 illustrates instance segmentation and roof region extraction, according to some embodiments. The instance segmentation engine 120 receives imagery tiles from the data ingestion subsystem 110, where each tile may depict one or more structures, surrounding terrain, vegetation, roadways, and other features.

The instance segmentation engine 120 applies an instance segmentation model 122 to each imagery tile to detect and delineate individual structural regions. In some embodiments focused on roof condition assessment, the instance segmentation model 122 is configured to detect individual roof regions. For each detected roof region, the model 122 produces: (a) a segmentation mask 124 indicating which pixels or regions of the tile correspond to the detected roof, (b) bounding coordinates 126 (e.g., a bounding box or bounding polygon), (c) a class label 127 (e.g., “roof”), and (d) a confidence value 128.

In some embodiments, the instance segmentation model 122 is a deep neural network architecture suitable for instance segmentation tasks, such as a Mask R-CNN architecture, a YOLACT architecture, a SOLOv2 architecture, or another instance segmentation architecture. The instance segmentation model 122 may be trained on a training dataset comprising both manually annotated real imagery and synthetically generated imagery. In some embodiments, the manually annotated imagery is annotated iteratively at large scale by human annotators who delineate roof polygon boundaries, and the annotation process includes quality assurance review and inter-annotator consistency checks. The training is performed in an iterative manner in which initial models are trained on a first subset of annotated imagery, applied to additional imagery to generate candidate annotations, the candidate annotations are reviewed and corrected by human annotators, and the corrected annotations are added to the training dataset for subsequent training iterations.

In some embodiments, the synthetically generated imagery is produced by rendering three-dimensional models of structures with varying roof materials, geometries, lighting conditions, atmospheric effects, and occlusion patterns (e.g., vegetation, shadows) to create diverse training examples that supplement the manually annotated real imagery. The use of synthetically generated training imagery may improve the model's generalization to structures and conditions not well-represented in the manually annotated dataset.

Following instance segmentation, a post-processing stage 129 applies one or more filtering rules to the detected instances. In some embodiments, the filtering rules include: (a) a minimum area threshold to exclude detections smaller than a minimum structural size, (b) non-maximum suppression to resolve overlapping detections, and (c) a confidence threshold to exclude low-confidence detections. In some embodiments, detected roof instances are mapped to property addresses by computing a geographic proximity between each detected instance and geocoded address locations, assigning each instance to the nearest address within a configurable matching radius.

In some embodiments involving multi-structure parcels (e.g., a residential property with a detached garage, or a commercial site with multiple buildings), each detected structural region is treated as a separate assessable instance, and the system 100 may produce separate structural condition indicators and scores for each instance or aggregate them according to a configurable rule.

### Image Enhancement Pipeline

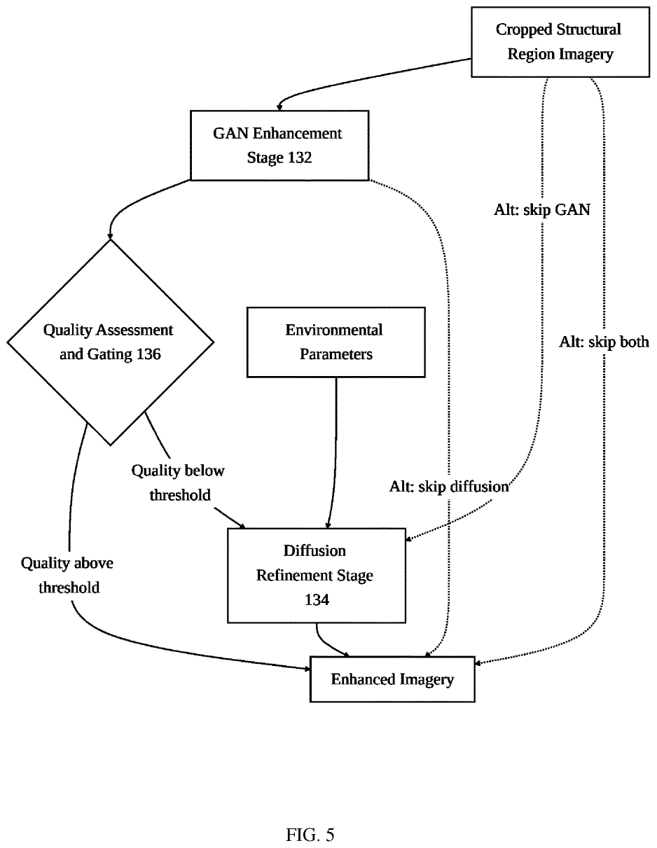

FIG. 5 illustrates the image enhancement pipeline 130, according to some embodiments. The image enhancement pipeline 130 receives cropped imagery corresponding to individual segmented structural regions from the instance segmentation engine 120. The image enhancement pipeline 130 is configured to improve the signal quality of the received imagery to facilitate more accurate downstream feature extraction and condition detection.

In some embodiments, the image enhancement pipeline 130 includes a GAN enhancement stage 132. The GAN enhancement stage 132 applies a generative adversarial network (GAN) trained to perform at least one of: super-resolution processing (increasing the effective spatial resolution of the imagery), denoising (reducing sensor noise, compression artifacts, or atmospheric noise), or occlusion artifact mitigation (reducing the visual impact of partial occlusions from vegetation, shadows, or other sources).

In some embodiments, the GAN comprises a generator network and a discriminator network trained in an adversarial fashion. The generator network receives input imagery and produces enhanced imagery. The discriminator network receives either the enhanced imagery from the generator or real high-quality reference imagery and produces an output indicating whether the received imagery is generated or real. Through iterative training, the generator learns to produce enhanced imagery that is indistinguishable from high-quality reference imagery while preserving structural features relevant to condition assessment.

In some embodiments, the GAN architecture comprises a residual-in-residual dense block (RRDB) architecture (e.g., adapted from Real-ESRGAN or similar super-resolution architectures), a Wasserstein GAN (WGAN) architecture with gradient penalty, or another GAN architecture suitable for image super-resolution or denoising. In some embodiments, the GAN is trained using a combination of loss functions including one or more of: an adversarial loss, a perceptual loss (e.g., computed from features extracted by a pre-trained classification network such as a VGG network), a pixel-wise reconstruction loss (e.g., L1 or L2 loss), or a structural similarity (SSIM) loss. In some embodiments, the total generator loss is computed as a weighted sum of the individual loss components, for example: L_total=w_adv*L_adv+w_perc*L_perc+w_pix*L_pix+w_ssim*L_ssim, where L_adv is the adversarial loss, L_perc is the perceptual loss, L_pix is the pixel-wise reconstruction loss, L_ssim is the structural similarity loss, and w_adv, w_perc, w_pix, and w_ssim are configurable weighting coefficients (e.g., w_adv approximately 0.01, w_perc approximately 1.0, w_pix approximately 1.0, w_ssim approximately 0.1, with relative weights adjusted based on training phase and convergence behavior). In some embodiments, the training uses an optimizer such as Adam or AdamW with a learning rate in a range of approximately 1e-4 to 1e-3, a batch size selected based on available GPU memory (e.g., in a range of 4 to 32), training is continued until convergence as measured by a validation loss plateau or a maximum number of training iterations (e.g., in a range of 50,000 to 500,000 iterations), and gradient clipping (e.g., clipping gradients by norm to a maximum value in a range of approximately 0.5 to 5.0) is applied to stabilize adversarial training. In some embodiments, the training dataset for the GAN comprises pairs of low-quality and high-quality imagery of structures, where the low-quality imagery may be derived by applying degradation operations (e.g., downsampling, noise injection, blur, compression artifact simulation) to high-quality reference imagery to create synthetic training pairs.

In some embodiments, the GAN enhancement stage 132 processes imagery at one or more configurable tile sizes (e.g., 256×256, 512×512, 1024×1024, 2048×2048, or 4096×4096 pixels), with the tile size selected based on the available spatial resolution of the input imagery and available computational resources. In some embodiments, the GAN enhancement stage 132 applies a configurable spatial upscaling factor (e.g., 2×or 4×) to increase the effective spatial resolution of the imagery. In some embodiments, multiple upscaling factors may be applied in sequence (e.g., two successive 2× upscaling passes) to achieve higher effective resolution while reducing hallucination artifacts compared to a single large upscaling step. In some embodiments, overlapping tile processing with blending is used to avoid boundary artifacts.

In some embodiments, the image enhancement pipeline 130 further includes a diffusion refinement stage 134. The diffusion refinement stage 134 applies a diffusion-based refinement model to the output of the GAN enhancement stage 132 (or to the original imagery if GAN enhancement is not applied) to address residual artifacts that may remain after GAN processing. In some embodiments, only the diffusion refinement stage 134 is applied without the GAN enhancement stage 132. In some embodiments, both the GAN enhancement stage 132 and the diffusion refinement stage 134 are applied in sequence, in either order. Each enhancement stage is independently optional, and the image enhancement pipeline 130 may comprise any combination of model-based enhancement stages appropriate to the input imagery characteristics. In some embodiments, the diffusion-based refinement model is conditioned on one or more environmental parameters associated with the structure being processed, such as the season or month of imagery capture, the geographic region, the weather conditions at the time of capture (if available), or a quality classification of the input imagery.

In some embodiments, the conditioning is implemented by concatenating a conditioning vector representing the environmental parameters with the input to the diffusion model, by using cross-attention mechanisms between the environmental parameter representation and intermediate features of the diffusion model, or by using classifier-free guidance with environmental parameter conditioning. The conditioned diffusion model may be particularly effective for refining imagery with weather-related artifacts (e.g., haze, cloud shadows, rain-induced blur) or seasonal artifacts (e.g., snow cover, leaf cover changes).

In some embodiments, the image enhancement pipeline 130 includes an adaptive gating mechanism 136 that determines, for each structure, whether to apply optional enhancement stages (e.g., the diffusion refinement stage 134) based on a quality assessment of the imagery after preceding enhancement stages. The gating mechanism 136 may evaluate one or more quality metrics (e.g., sharpness, noise level, artifact presence) and compare them against thresholds to decide whether additional refinement would provide sufficient improvement to justify the additional computational cost. In some embodiments, the gating mechanism 136 is configured differently for different geographic regions, seasons, or imagery source types based on historical performance data.

### Feature Extraction and Structural Condition Detection

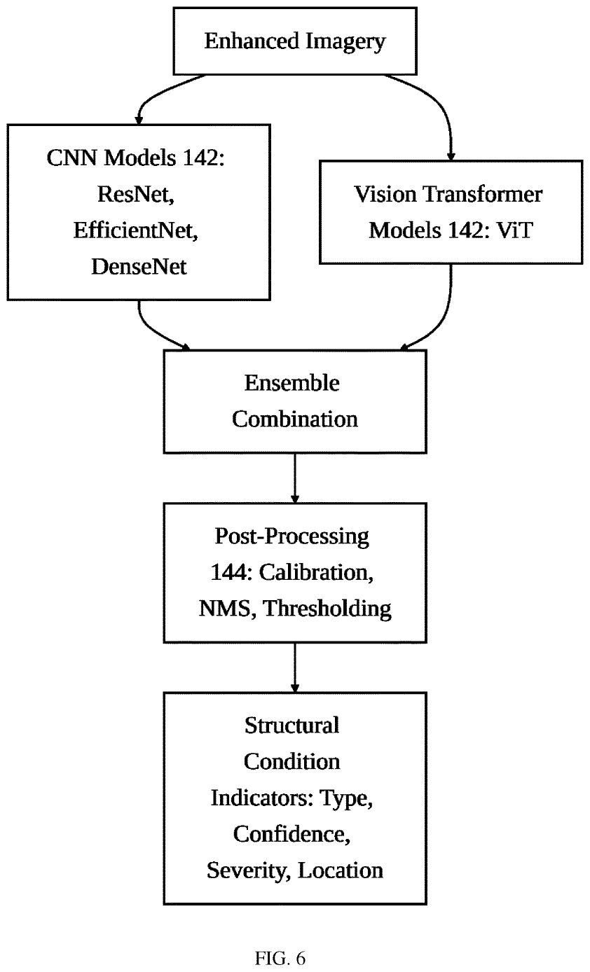

FIG. 6 illustrates feature extraction and structural condition detection, according to some embodiments. The feature extraction engine 140 receives enhanced imagery from the image enhancement pipeline 130 and applies one or more feature extraction models 142 to produce structural condition indicators for each assessed structure.

In some embodiments, the feature extraction models 142 comprise one or more convolutional neural network (CNN) architectures (e.g., ResNet, EfficientNet, or DenseNet family architectures), one or more vision transformer (ViT) architectures, or an ensemble combining CNN and transformer architectures. In some embodiments, an ensemble approach processes the enhanced imagery through multiple model architectures and combines their outputs (e.g., by averaging, weighted averaging, or a learned combination function) to produce more robust structural condition indicators.

Each structural condition indicator produced by the feature extraction engine 140 includes at least: (a) an attribute or condition type identifier drawn from a defined taxonomy, (b) a confidence value indicating the model's estimated reliability for the detection, and optionally (c) a severity or measurement value (e.g., a discrete grade from 1 to 5, a continuous value from 0.0 to 1.0, or a physical measurement), and (d) spatial coordinates indicating the location of the detected attribute or condition within the imagery.

In some embodiments, the taxonomy includes one or more of the following condition types: missing roofing material (e.g., missing shingles or tiles), cracked or split roofing material, impact damage (e.g., hail impact marks or dents), wind-induced displacement (e.g., lifted or curled shingles), moisture accumulation (e.g., ponding water on flat roofs), biological growth (e.g., moss, algae, or lichen), flashing displacement or damage, debris accumulation, tarp or temporary covering (indicating prior acknowledged damage), and general aging or wear indicators. In some embodiments, the taxonomy additionally or alternatively includes attribute types such as: roof material type (e.g., asphalt shingle, EPDM, TPO, built-up roof, metal standing seam, slate, cedar shake, tile), roof geometry or complexity, estimated component dimensions, manufacturer or brand identification, surface composition indicators, solar panel presence or suitability, and structural orientation. In some embodiments, the taxonomy may be extended to include non-roof structural attributes or conditions such as siding condition, gutter condition, window condition, or foundation indicators when the system 100 is configured for extended property service assessment.

In some embodiments, the feature extraction engine 140 produces, for each structure, a probability vector comprising a probability value for each condition type in the taxonomy, along with spatial coordinate data indicating the locations of detected conditions within the imagery. The probability vector and spatial data are stored in the per-structure data record in the storage and caching layer 195.

In some embodiments, the feature extraction models 142 are trained using supervised learning on a training dataset comprising imagery annotated with ground truth condition labels. In some embodiments, the training dataset is assembled from multiple sources including: (a) manually annotated imagery labeled by domain experts who identify and delineate condition regions and assign condition type and severity labels, (b) synthetically generated imagery with programmatically applied condition patterns (e.g., rendered damage textures composited onto clean roof imagery with varying lighting, angles, and weather conditions), (c) imagery with labels derived from building permit records (e.g., a permit for roof repair following a hailstorm may serve as a positive label for hail damage), (d) imagery with labels derived from human reviewer annotations captured through the human review module 180, and (e) labels derived from change detection across multiple temporal captures of the same structure, where detected changes correlated with known weather events serve as weak supervision signals. In some embodiments, a semi-supervised or self-supervised learning approach is used to leverage unlabeled imagery in combination with the labeled examples, for example by pre-training an encoder on a large corpus of unlabeled aerial imagery using a contrastive or masked image modeling objective and then fine-tuning on the labeled condition detection task.

In some embodiments, the feature extraction models 142 are trained using a multi-task loss function comprising one or more of: a binary cross-entropy loss for individual condition type detection heads, a mean squared error (MSE) or L1 loss for continuous severity estimation heads, a boundary-aware loss (e.g., dice loss or focal loss) for spatial condition localization heads, and a cross-entropy loss for material classification heads. In some embodiments, the multi-task loss is computed as a weighted sum of the individual task losses, with task-specific weights selected based on task importance and relative difficulty. In some embodiments, the training uses an optimizer such as AdamW with a learning rate in a range of approximately 1e-5 to 1e-3, a learning rate schedule comprising a warmup phase followed by cosine decay, a batch size selected based on available GPU memory (e.g., in a range of 16 to 256), and an early stopping criterion based on validation performance on a held-out dataset.

In some embodiments, the training process employs data augmentation techniques to increase the effective diversity of the training dataset and improve model generalization. The data augmentation techniques may include one or more of: geometric transformations (e.g., rotation, flipping, random cropping, perspective warping), photometric transformations (e.g., brightness adjustment, contrast adjustment, color jitter, hue shift), simulated degradation (e.g., adding Gaussian noise, applying motion blur, simulating compression artifacts, applying atmospheric haze), and domain-specific augmentations (e.g., simulated shadow patterns, simulated seasonal vegetation changes, simulated partial occlusion). In some embodiments, the augmentation parameters are sampled from predefined ranges during training to expose the model to a diverse set of capture conditions.

In illustrative, non-limiting empirical evaluations, applying GAN-based enhancement to commodity aerial imagery at approximately 15 cm ground sampling distance before feature extraction improved condition detection mean average precision (mAP) from approximately 0.65 without enhancement to approximately 0.82 with enhancement, measured across all condition types in the taxonomy on a held-out validation dataset of approximately 5,000 annotated roof images. Recall for individual condition types improved from a range of approximately 0.55 to 0.70 (without enhancement) to a range of approximately 0.75 to 0.87 (with enhancement). Applying diffusion-based refinement after GAN enhancement provided an additional approximately 0.03 to 0.05 improvement in mAP for imagery tiles exhibiting atmospheric artifacts or heavy shadow casting. For the scoring subsystem 160, a recommendation score computed using the full multimodal fusion of imagery-derived indicators, weather event data, building metadata, and permit-based condition signals achieved an area under the receiver operating characteristic curve (AUROC) of approximately 0.84 for predicting confirmed service outcomes, compared to an AUROC of approximately 0.71 for a baseline model using only imagery-derived indicators without weather or metadata fusion. In batch processing mode, the system processed approximately 2,500 to 8,000 structures per hour on a computing system with four graphics processing units, with throughput varying based on imagery resolution, enhancement stages applied, and cache hit rate. These performance values are illustrative and may vary based on geographic region, imagery source characteristics, model architecture selections, training data composition, and other implementation-specific parameters.

In some embodiments, a post-processing stage 144 refines the raw outputs of the feature extraction models 142 by applying one or more of: confidence calibration (adjusting raw model confidence outputs to better approximate true probabilities), non-maximum suppression (resolving overlapping spatial detections), aggregation across overlapping tiles (combining detections from multiple overlapping tiles covering the same structure), and thresholding (suppressing detections below a minimum confidence threshold).

### Temporal Comparison

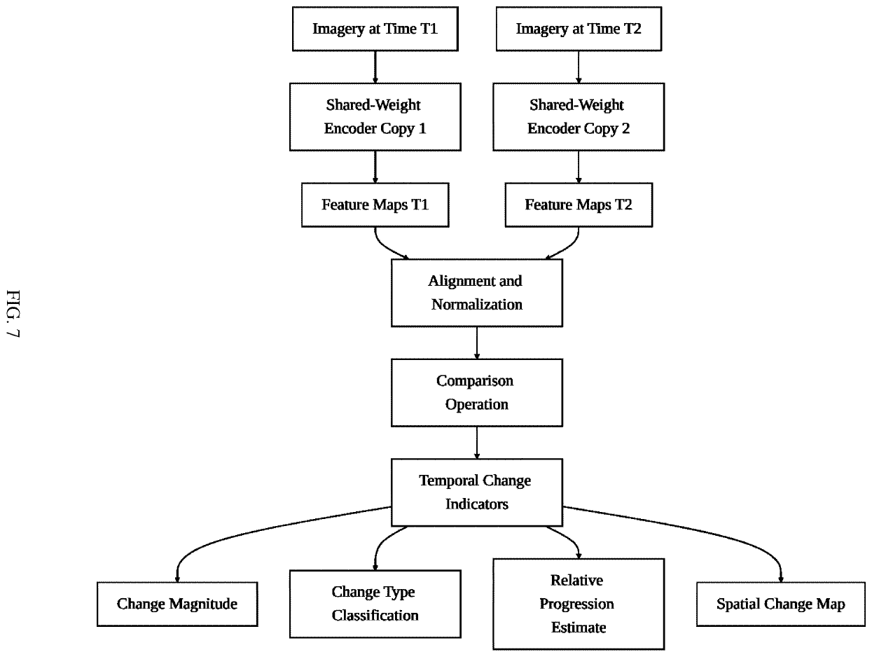

FIG. 7 illustrates the temporal comparison module 150, according to some embodiments. When imagery of a given structure captured at a first time (T1) and imagery of the same structure captured at a second time (T2) are available, the temporal comparison module 150 compares the two temporal captures to generate one or more temporal change indicators.

In some embodiments, the temporal comparison module 150 operates by extracting feature representations from the imagery at each time using a shared feature extraction model (e.g., a shared-weight neural network encoder), and then applying a comparison operation to the extracted feature representations. The comparison operation may comprise one or more of: element-wise difference of feature vectors, cosine similarity computation between feature vectors, a learned comparison head (e.g., a small neural network that takes concatenated or differenced feature representations as input and produces change indicators as output), or a combination thereof.

In some embodiments, the temporal comparison module 150 uses a Siamese network architecture in which two copies of the same neural network (with shared weights) process the imagery from T1 and T2 respectively, and a comparison layer processes the paired outputs. In some embodiments, the temporal comparison module 150 operates at a feature-map level rather than at a pixel level, computing differences or similarities between intermediate feature maps extracted from corresponding spatial positions in the T1 and T2 imagery.

In some embodiments, the temporal change indicators produced by the temporal comparison module 150 include one or more of: (a) a change magnitude indicator representing the overall degree of detected change, (b) a change type classification (e.g., new damage detected, repair detected, vegetation change, no significant change), (c) a relative condition progression estimate (e.g., an indication of whether the structure's condition has degraded, improved, or remained stable between T1 and T2), and (d) a spatial change map indicating which regions of the structure exhibit the most significant change. The temporal change indicators are incorporated into the per-structure data record and may be used as additional inputs to the scoring subsystem 160.

In some embodiments, the imagery at T1 and T2 may have been captured under different conditions (e.g., different seasons, different lighting, different sensor platforms). The temporal comparison module 150 may include an alignment preprocessing step that geometrically registers the two captures and normalizes for differences in illumination, contrast, or color balance before performing the feature comparison. In some embodiments, the alignment is performed at a feature-map level rather than at a raw pixel level, leveraging learned feature representations that are more robust to appearance changes while preserving structural geometry. In some embodiments, the temporal comparison module 150 is trained to distinguish between genuine structural condition changes (e.g., new damage, completed repairs) and non-structural appearance changes (e.g., lighting differences, seasonal foliage variations, different sensor characteristics), reducing false change detections that could affect scoring accuracy.

### Recommendation Score Computation

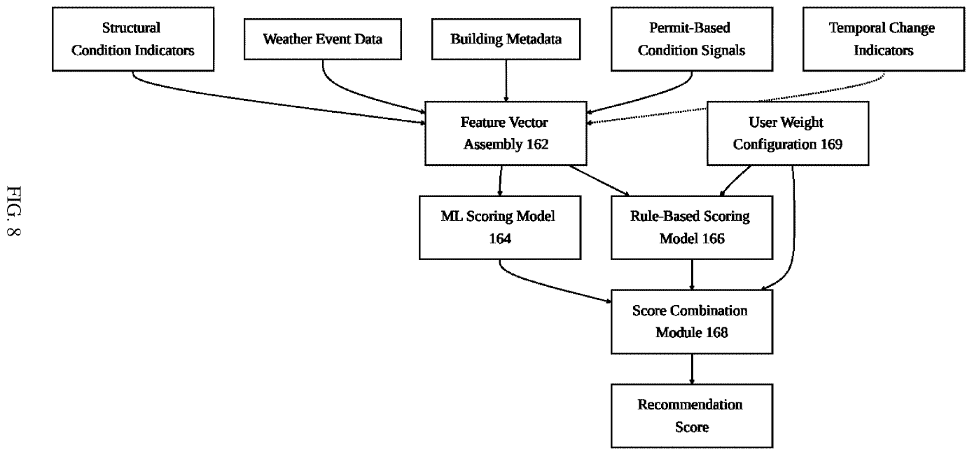

FIG. 8 illustrates the scoring subsystem 160, according to some embodiments. The scoring subsystem 160 receives, for each structure, the set of structural condition indicators from the feature extraction engine 140, optional temporal change indicators from the temporal comparison module 150, weather event data and building metadata from the data ingestion subsystem 110, and optional permit-based condition signals. The scoring subsystem 160 computes a recommendation score for each structure by fusing these inputs according to a configurable weighting scheme.

In some embodiments, the scoring subsystem 160 assembles a feature vector 162 for each structure by combining: (a) features derived from the structural condition indicators (e.g., individual condition probabilities, maximum condition severity, number of conditions exceeding a threshold), (b) features derived from weather event data (e.g., maximum hail diameter within a temporal window, maximum wind speed, number of severe weather events, cumulative precipitation, freeze-thaw cycle count), (c) features derived from building metadata (e.g., estimated structure age, roof material category, structure area, assessed value), and (d) optionally, features derived from permit-based condition signals (e.g., time since last repair permit, presence of damage-related permits). In some embodiments, the feature vector 162 also includes features derived from temporal change indicators when available.

In some embodiments, the scoring subsystem 160 includes a machine-learned scoring model 164, which may be a gradient-boosted decision tree model (e.g., XGBoost), a neural network model, a logistic regression model, a random forest model, or another supervised learning model trained on historical data associating feature vectors with known recommendation outcomes (e.g., confirmed damage requiring repair, successful service engagements, or other outcome data corresponding to the configured recommendation objective). The machine-learned scoring model 164 processes the feature vector 162 and produces a predicted score. In some embodiments, the machine-learned scoring model 164 is trained on ground truth labels corresponding to the specific recommendation objective of the service provider or property stakeholder (e.g., confirmed damage requiring repair for a maintenance prioritization objective, successful service engagements for a conversion optimization objective, or verified energy efficiency improvements for an energy assessment objective), such that different recommendation objectives produce different trained models from the same underlying feature vector, enabling the scoring subsystem 160 to serve diverse use cases without modifying the upstream processing pipeline.

In some embodiments, the scoring subsystem 160 includes a rule-based scoring model 166 that applies a configurable set of rules and weights to the feature vector 162. The rule-based scoring model 166 may compute a weighted sum of selected features, apply threshold-based adjustments, or apply conditional rules (e.g., “if hail diameter exceeds 1.5 inches and structure age exceeds 15 years, add a bonus to the score”). The weights and rules of the rule-based scoring model 166 may be configured by a system operator, by a user through the user interface layer 190, or by a combination thereof.

In some embodiments, the scoring subsystem 160 includes a score combination module 168 that combines or selects between the outputs of the machine-learned scoring model 164 and the rule-based scoring model 166. The combination may be a weighted average, a maximum, a learned blending function, or a selection based on configuration (e.g., a user preference for rule-based scoring or ML-based scoring). The output of the score combination module 168 is the recommendation score for the structure.

In some embodiments, the recommendation score is a numerical value on a scale of 0 to 100, where higher values indicate a higher estimated priority or suitability for a given service or intervention. In some embodiments, the recommendation score is a multi-dimensional vector comprising values for a plurality of recommendation dimensions (e.g., inspection priority, maintenance urgency, upsell potential, energy efficiency opportunity). In some embodiments, the score is additionally or alternatively represented as a categorical classification (e.g., High, Medium, Low priority) based on configurable threshold values. The recommendation score is not limited to representing inspection need; it may represent any property-relevant assessment objective configured by the user or learned from outcome data.

As an illustrative, non-limiting example, a first residential structure located in an area that experienced a severe hail event (maximum hail diameter of 2 inches) three months ago, having a roof age of 18 years with detected asphalt shingle material and moderate roof complexity, with detected missing material (confidence 0.85, severity 0.6) and detected impact marks (confidence 0.78, severity 0.5), might receive a recommendation score of 87 for a maintenance prioritization objective. A second residential structure in the same area, having a roof age of 3 years with a metal standing seam roof, with no detected conditions above the confidence threshold, might receive a recommendation score of 22. A third structure with moderate detected conditions but located in an area with no recent severe weather events might receive an intermediate score of 45. In an alternative embodiment configured for a commercial portfolio management objective, the recommendation score might additionally incorporate factors such as estimated cost of intervention, remaining useful roof life, and upsell potential for additional property services.

### Configurable Weighting and User Personalization

In some embodiments, the scoring subsystem 160 supports user-configurable weighting, allowing a user to adjust the relative influence of different input categories on the computed recommendation score. FIG. 8 illustrates a user weight configuration interface 169 through which a user may adjust weighting parameters.

In some embodiments, the configurable parameters include one or more of: a weather severity weight (controlling the influence of weather event data on the score), a structure age weight (controlling the influence of building age), a condition severity weight (controlling the influence of detected structural conditions), a geographic preference filter (e.g., prioritizing structures within specified postal codes or regions), a structure type filter (e.g., residential only, commercial only, or both), and custom rule thresholds (e.g., minimum structure age, minimum hail diameter).

In some embodiments, different users of the system 100 (e.g., different service provider organizations or individual service providers within an organization) may maintain separate weight configurations, such that the same set of raw structural condition indicators and contextual data produce different recommendation scores for different users based on their respective configurations. In some embodiments, weight configurations may be associated with geographic regions, such that a user's preferred weighting differs by region based on regional characteristics (e.g., climate patterns, building stock age distribution).

In some embodiments, the system 100 provides suggested weight configurations based on historical outcome data (e.g., which weight configurations have historically correlated with higher rates of confirmed findings or successful service engagements in a given region).

### Engagement Artifact Generation

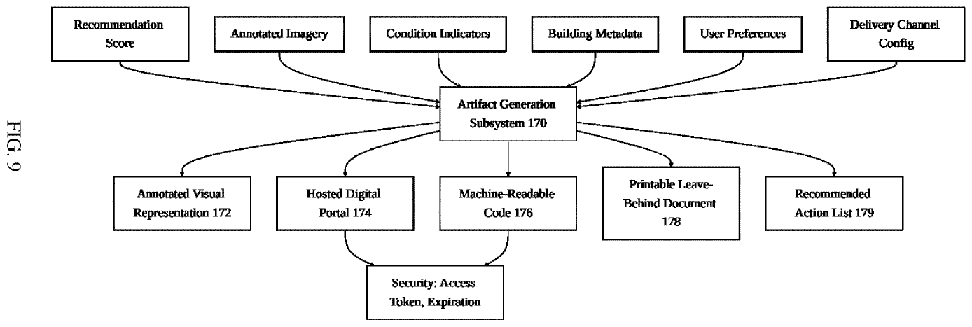

FIG. 9 illustrates the artifact generation subsystem 170, according to some embodiments. For structures having recommendation scores satisfying a selection criterion (e.g., exceeding a configurable threshold, or being within a top percentile for a given geographic area), the artifact generation subsystem 170 automatically generates one or more property-specific engagement artifacts.

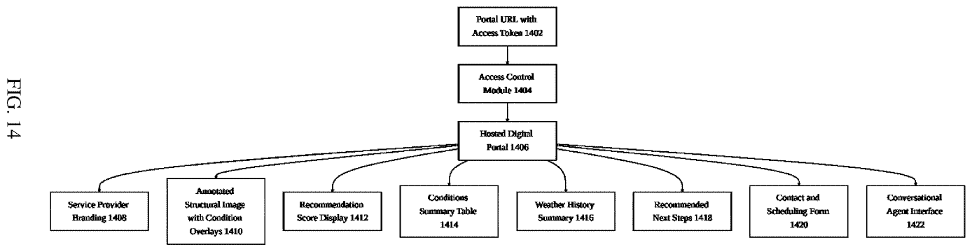

In some embodiments, the engagement artifacts include one or more of the following types:
(a) An annotated visual representation 172: an image of the assessed structure (derived from the enhanced imagery or the original imagery) with graphical overlays indicating the locations and types of detected structural conditions, annotated with the recommendation score and optionally with condition-specific labels, severity indicators, or recommended actions.
(b) A hosted digital portal 174: a web-accessible page dedicated to the specific assessed structure, hosted on the system 100 or an associated web server, containing the annotated visual representation, a summary of detected conditions, the recommendation score, recommended next steps (e.g., scheduling an inspection, contacting a service provider), and optionally an interface to a conversational agent module. In some embodiments, the hosted digital portal 174 includes weather history information, building metadata, and explanatory content describing the analysis findings. FIG. 14 illustrates an example layout of a homeowner-facing engagement portal, according to some embodiments. As illustrated in FIG. 14, a portal URL with an access token 1402 is validated by an access control module 1404, and the portal 1406 presents service provider branding 1408, an annotated structural image with condition overlays 1410, the recommendation score 1412, a conditions summary table 1414, a weather history summary 1416, recommended next steps 1418, a contact or scheduling form 1420, and optionally a conversational agent interface 1422.
(c) A machine-readable code 176: a QR code, barcode, or other machine-readable visual code that encodes or links to a URL of the hosted digital portal 174 for the corresponding structure. The machine-readable code 176 enables physical-to-digital bridging. For example, a service provider may include the code on a printed document left at the property, enabling the property owner to scan the code with a mobile device and access the hosted digital portal 174.
(d) A printable leave-behind document 178: a formatted document (e.g., PDF) suitable for printing and physical distribution, containing a summary of the analysis findings, the annotated visual representation, the recommendation score, the machine-readable code, and contact information for the service provider. In some embodiments, the leave-behind document 178 is generated in one or more configurable templates tailored to residential properties, commercial properties, or other property classifications.
(e) A recommended action list 179: a set of suggested next steps for the service provider and/or the property owner, generated based on the detected conditions, the recommendation score, the property classification, and optionally the service provider's historical engagement patterns.

In some embodiments, the artifact generation subsystem 170 selects which artifact types to generate based on a user preference, a property classification (e.g., residential vs. commercial), or a delivery channel configuration (e.g., digital-only, print-only, or both). In some embodiments, the artifact generation subsystem 170 generates artifacts in batch for a plurality of structures in response to a single user request specifying a geographic boundary.

In some embodiments, access to the hosted digital portal 174 is controlled by a security mechanism including one or more of: an opaque unguessable access token embedded in the URL, an expiration time after which the portal becomes inaccessible or redirects to a general information page, rate-limiting to prevent automated scraping, and an audit log recording access events.

### Conversational Agent Integration

In some embodiments, the system 100 includes a conversational agent module 175 that may be embedded in the hosted digital portal 174 or in a service provider's web presence. The conversational agent module 175 is configured to interact with property owners or other users using natural language, leveraging the stored analysis data for the specific property to provide context-aware responses.

In some embodiments, the conversational agent module 175 is configured to perform one or more of: answering questions about the detected structural attributes and conditions, explaining the recommendation score and its component factors, providing general information about maintenance or repair options, recommending specific improvements or interventions based on the detected conditions and property characteristics, scheduling an inspection or service appointment with the service provider via integration with a scheduling service, providing cost estimate ranges based on the detected conditions and property characteristics, presenting tailored action plans, and providing code compliance or regulatory guidance relevant to the detected conditions.

In some embodiments, the conversational agent module 175 is implemented using a large language model (LLM) with retrieval-augmented generation (RAG), where the retrieval component accesses the per-structure data record (including structural condition indicators, weather data, building metadata, and the recommendation score) to ground the agent's responses in property-specific factual data. In some embodiments, the conversational agent module 175 is subject to guardrails that restrict its outputs to topics within its configured scope, prevent it from making definitive diagnostic statements, and escalate to a human representative when the conversation falls outside the agent's competency.

### Human Review and Active Learning

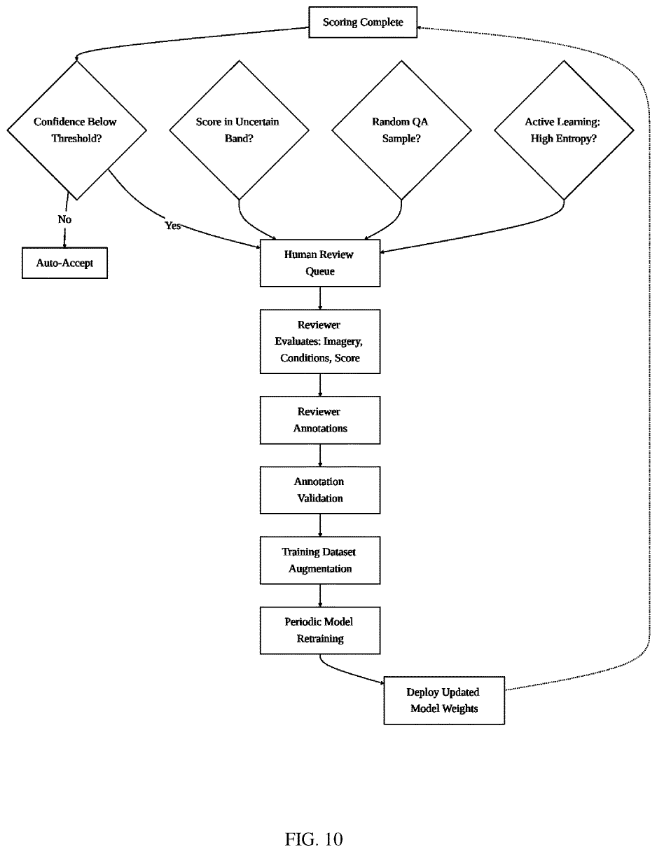

FIG. 10 illustrates the human review module 180 and an active learning loop, according to some embodiments. The human review module 180 is configured to receive structures that have been flagged for human review based on one or more routing criteria.

In some embodiments, the routing criteria include one or more of: (a) a confidence threshold, wherein structures for which one or more structural condition indicators have confidence values below a review threshold are routed for review; (b) a score band threshold, wherein structures with recommendation scores in an uncertain range (e.g., between 40 and 60 on a 0 -100 scale) where the scoring outcome is most sensitive to potential detection errors are routed for review; (c) a random sampling criterion, wherein a configurable percentage of all processed structures are randomly selected for quality assurance review regardless of confidence; and (d) an active learning criterion, wherein structures for which the model's prediction uncertainty is highest (e.g., as measured by entropy of the condition probability vector) are selected for review to maximize the information gain from human annotation.

In some embodiments, the review interface presents to the human reviewer: the original imagery of the structure, the enhanced imagery, the detected structural condition indicators with their confidence values and spatial locations, the computed recommendation score, and relevant contextual information (e.g., weather history, building metadata). The reviewer may confirm, correct, or reject individual condition detections, and may add additional condition annotations not detected by the model.

In some embodiments, reviewer annotations are captured in a structured format comprising: an annotation action (confirm, correct, reject, or add), a condition type, a severity value, spatial coordinates, and a reviewer identifier. The structured annotations are validated (e.g., checked for completeness and consistency) and converted into training examples that are added to the model training dataset. In some embodiments, the system 100 periodically retrains one or more of the instance segmentation model, the image enhancement models, or the feature extraction models using the augmented training dataset, deploying updated model weights to improve future prediction accuracy.

### Continuous Monitoring

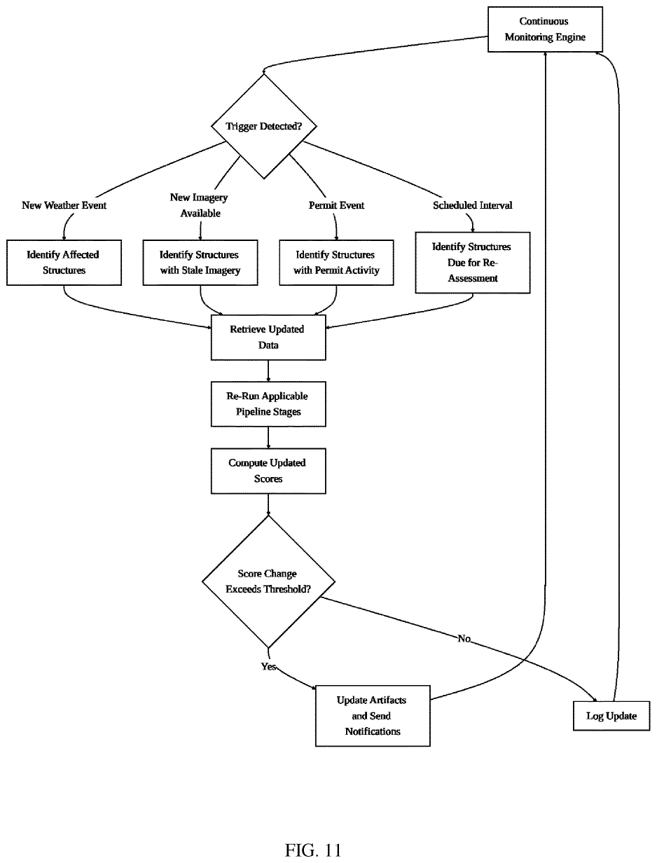

FIG. 11 illustrates a continuous monitoring workflow, according to some embodiments. In some embodiments, the system 100 supports a continuous monitoring mode in which previously assessed structures within a monitored geographic region are periodically re-assessed when new data becomes available.

In some embodiments, the continuous monitoring workflow is triggered by one or more of: (a) a new weather event affecting the monitored region (e.g., a new hailstorm, a severe wind event), (b) new imagery becoming available for structures in the monitored region (e.g., updated satellite imagery from a provider), (c) a permit event detected for a monitored structure, or (d) a scheduled periodic re-assessment interval.

When a trigger event occurs, the system 100 identifies the affected structures, retrieves updated data for the relevant data source(s), and re-runs the applicable pipeline stages. In some embodiments, the system 100 may skip previously completed stages if the relevant input data has not changed (e.g., if only weather data has been updated, the instance segmentation and image enhancement stages may be skipped if the imagery has not changed, and only the scoring computation is re-executed with the updated weather data).

In some embodiments, the system 100 computes an updated recommendation score and compares it to the previously stored score. If the score change exceeds a significance threshold, the system 100 may generate updated engagement artifacts and/or transmit a notification to the user (e.g., via email, SMS, push notification, or in-application alert) indicating the score change and the triggering event.

### Permit and Public Record Integration

In some embodiments, the system 100 integrates building permit records and other public records as inputs to the condition assessment and scoring pipeline. The data ingestion subsystem 110 acquires permit records from one or more public record sources, normalizes the records to a common schema, and links each record to the corresponding structure.

In some embodiments, the normalized permit schema includes one or more of: permit identifier, filing date, permit type (e.g., building, roofing, electrical, mechanical), permit status (e.g., filed, issued, finaled, expired), work description text, estimated project valuation, issuing jurisdiction, and a standardized address or parcel identifier linking the permit to a structure.

In some embodiments, the system 100 applies a rule-based extraction process to permit work description text fields to identify roof-relevant signals. The rule-based extraction process may include keyword matching (e.g., “roof,” “shingle,” “reroof,” “hail,” “storm damage,” “leak repair”), pattern matching, and negation detection (e.g., excluding permits that mention “roof” only in the context of rooftop HVAC work). Each extracted signal is assigned a confidence value based on the specificity and clarity of the match.

In some embodiments, the system 100 additionally or alternatively applies a machine-learned classification model to permit records to produce permit-based condition signals. The classification model may be trained on a training dataset of permit records annotated by human domain experts, where each annotated permit record is labeled with one or more condition-relevant categories (e.g., “prior roof repair,” “storm damage claim,” “new roof installation,” “not roof-relevant”).

In some embodiments, the permit-based condition signals are used as additional features in the scoring subsystem 160. For example, a recent roof repair permit may reduce the recommendation score (indicating the structure was recently serviced), while a damage-related permit filing without a subsequent repair completion permit may increase the score (indicating acknowledged but unresolved damage). In some embodiments, a configurable suppression rule prevents the system 100 from generating engagement artifacts for structures that have a recent completed roof repair permit within a configurable time window (e.g., within the last 1 to 3 years).

### End-to-end Operational Flow

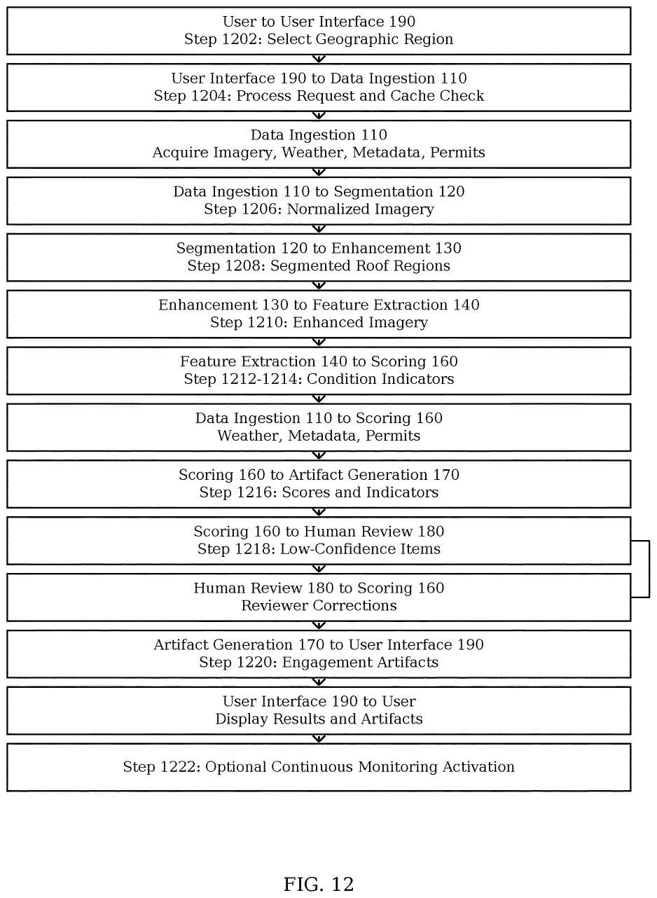

FIG. 12 illustrates an end-to-end operational flow, according to some embodiments. The following describes a representative non-limiting example of the system 100 processing a user request.

In step 1202, a user (e.g., a roofing service provider) accesses the user interface layer 190 and selects a geographic region for analysis. The selection may be performed by placing a pin on a map, drawing a boundary on a map, uploading a batch list of addresses, or submitting an address via text, email, or telephone interface.

In step 1204, the data ingestion subsystem 110 resolves the selected region to a set of target structures and performs a cache check. For cache misses, the subsystem 110 acquires imagery, weather data, building metadata, and permit records for the target structures.

In step 1206, the instance segmentation engine 120 processes acquired imagery tiles to detect and delineate individual roof regions, producing segmentation masks for each detected structure.

In step 1208, the image enhancement pipeline 130 applies GAN-based super-resolution and/or denoising to the segmented roof imagery to produce enhanced imagery. Optionally, the diffusion refinement stage 134 further refines the enhanced imagery.

In step 1210, the feature extraction engine 140 processes the enhanced imagery to produce structural condition indicators for each structure, including condition types, confidence values, severity values, and spatial coordinates.

In step 1212, optionally, if imagery from a prior time period is available, the temporal comparison module 150 compares the current and prior feature representations to produce temporal change indicators.

In step 1214, the scoring subsystem 160 assembles a feature vector for each structure and computes a recommendation score by fusing structural condition indicators, weather data, building metadata, permit signals, and optional temporal change indicators according to the user's configured weighting scheme.

In step 1216, the artifact generation subsystem 170 generates property-specific engagement artifacts for structures having scores satisfying the selection criterion. The generated artifacts include annotated visual representations, hosted digital portals, machine-readable codes, and optionally printable leave-behind documents.

In step 1218, structures with confidence values below the review threshold are routed to the human review module 180 for expert evaluation.

In step 1220, the user interface layer 190 presents the results to the user, including a prioritized list or map of assessed structures, their recommendation scores, and links to the generated engagement artifacts.

In step 1222, optionally, the system 100 activates continuous monitoring for the selected region, monitoring for trigger events that would prompt re-assessment.

### Alternative Embodiments and Extended Applications

While the preceding description has focused primarily on roof condition assessment for residential and commercial structures, the system 100 and methods described herein may be applied to assessment of other structural components and property types without departing from the principles of the invention.

In some embodiments, the system 100 is configured to assess siding condition, gutter condition, window condition, foundation-related indicators (e.g., visible settling or cracking), or solar panel condition using corresponding condition taxonomies and feature extraction models trained on imagery depicting the relevant structural components.

In some embodiments, the system 100 is configured for commercial property portfolio monitoring, where a portfolio manager, asset manager, or chief financial officer submits a list of commercial properties for periodic assessment, and the system 100 generates portfolio-level summary reports, individual property assessment artifacts, and maintenance planning recommendations including estimated intervention costs, return-on-investment projections, and budget allocation guidance. In some embodiments, the system 100 performs counterfactual analysis to estimate the financial impact of deferring maintenance versus performing immediate intervention, enabling data-driven capital expenditure planning. In some embodiments, the recommendation score for commercial properties incorporates financial factors such as cost of intervention, expected remaining useful life, insurance implications, and regulatory compliance considerations.

In some embodiments, the system 100 is configured for multi-service-provider operation, where multiple service provider organizations share access to the system 100 with respective user configurations, and the system 100 maintains tenant-isolated data stores for each organization while sharing common upstream imagery processing infrastructure. In some embodiments, the system 100 assigns exclusive geographic targeting zones to different service providers within a multi-provider network.

In some embodiments, the system 100 supports an inbound analysis mode in which a property owner accesses a service provider's web presence, submits a property address, and receives a property-specific assessment and engagement artifact generated by the system 100 in real-time or near-real-time.

In some embodiments, the system 100 integrates with one or more external customer relationship management (CRM) systems to import and export lead data, synchronize engagement status, and leverage historical engagement outcome data to refine scoring models and outreach recommendations.

In some embodiments, the system 100 incorporates route optimization for field operations, generating suggested visit sequences for a set of high-scoring structures based on geographic proximity, travel time estimates, and user-configured priority criteria.

In some embodiments, the system 100 incorporates demographic data (e.g., estimated household income, homeownership status, property turnover rate) from public or licensed data sources as additional features in the scoring subsystem 160 or as inputs to the artifact personalization process. The use of demographic data may be governed by compliance controls configured to ensure adherence to applicable regulations.

### Deployment Configurations

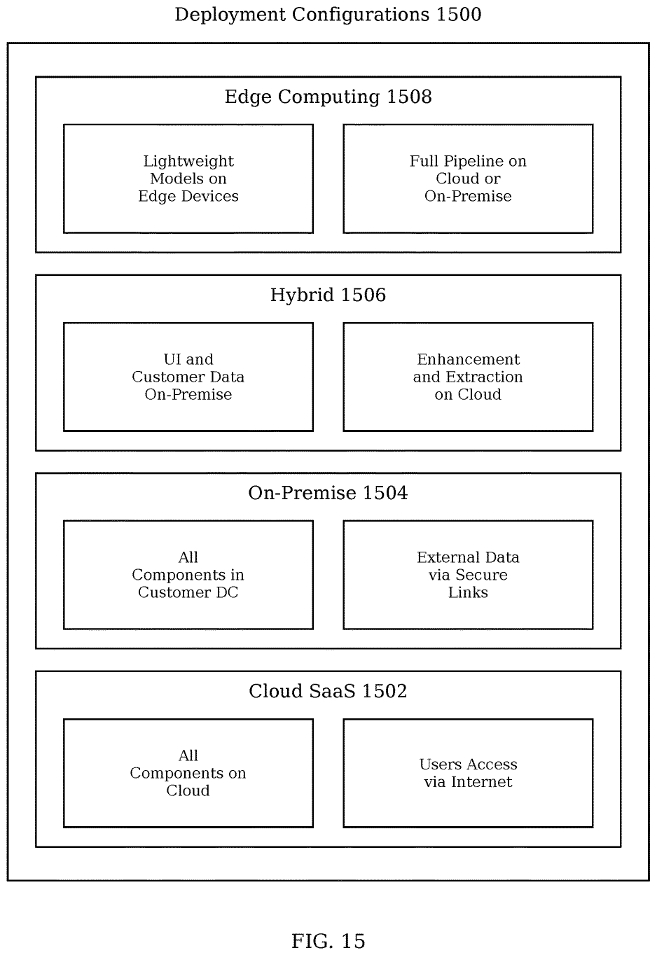

FIG. 15 illustrates deployment configurations 1500, according to some embodiments. The system 100 may be deployed in one or more of the following configurations:
(a) Cloud-hosted software-as-a-service (SaaS) configuration 1502: The system 100 is hosted on one or more cloud computing platforms (e.g., public cloud providers) and accessed by users through the user interface layer 190 via web browsers or mobile applications over the internet. In some embodiments, the system 100 is deployed across multiple cloud availability zones or regions for redundancy and low-latency access.
(b) On-premise deployment configuration 1504: The system 100 is deployed on computing infrastructure within a customer's own data center or facility, providing data isolation and local processing for customers with data residency requirements or other on-premise preferences. In some embodiments, on-premise deployments connect to external data sources (e.g., imagery providers, weather APIs) through secure network connections.
(c) Hybrid deployment configuration 1506: Portions of the system 100 are deployed on-premise (e.g., the user interface layer 190 and storage of customer-specific data) while other portions (e.g., the computationally intensive image enhancement and feature extraction pipelines) are executed on cloud infrastructure.
(d) Edge computing configuration 1508: In some embodiments, selected components of the system 100 (e.g., a lightweight scoring model, a personalized recommendation model, or future language model capabilities) are deployed on edge computing devices closer to the user or the data source, reducing latency for time-sensitive operations while the full processing pipeline remains available on cloud or on-premise infrastructure.

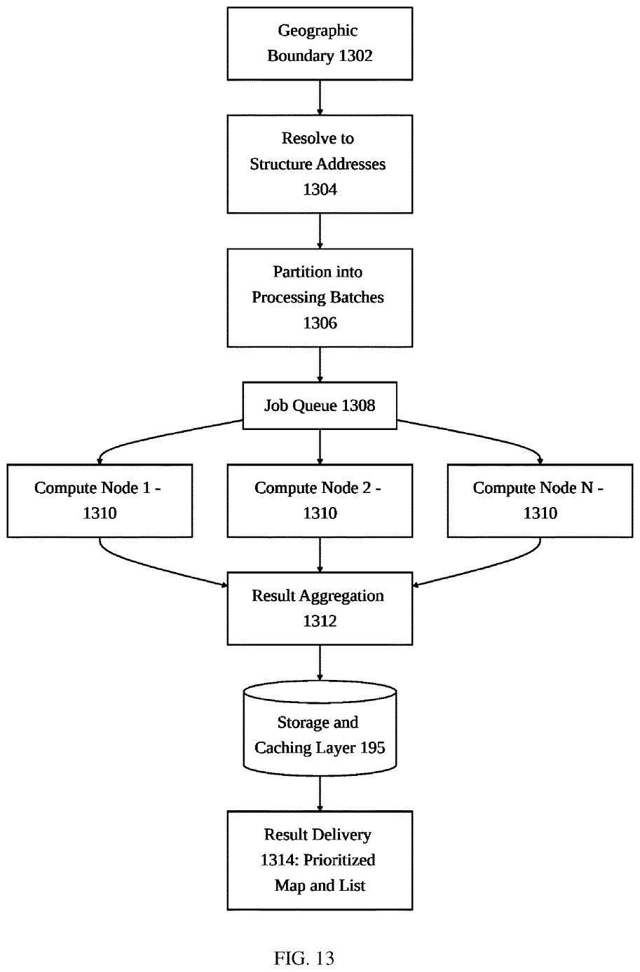

In some embodiments, the system 100 supports horizontal scaling by distributing processing of different structures across multiple computing nodes, using a message queue or job scheduling system to manage the distribution and collection of results. FIG. 13 illustrates geographic region processing and batch operations, according to some embodiments. As illustrated in FIG. 13, a user specifies a geographic boundary 1302, the system resolves the boundary to a set of structure addresses 1304, partitions the structures into processing batches 1306, dispatches the batches to a job queue 1308, processes each batch on one or more compute nodes 1310, aggregates the results 1312, stores the aggregated results in the storage and caching layer 195, and delivers the results to the user as a prioritized map and list 1314. In some embodiments, a batch processing request for a large geographic region is decomposed into sub-regions or individual structure requests that are processed in parallel across the available computing nodes.

### Computing System Environment

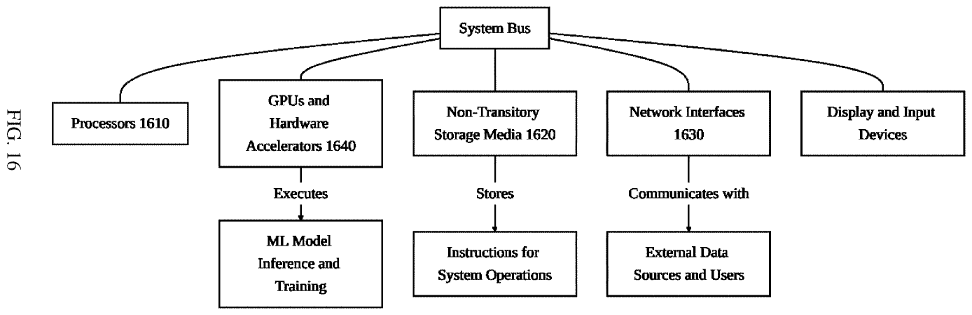

FIG. 16 illustrates a computing system environment 1600, according to some embodiments. The computing system environment 1600 may be used to implement any of the components of the system 100 described herein. The computing system environment 1600 includes one or more processors 1610, one or more non-transitory computer-readable storage media 1620 (e.g., solid-state drives, hard disk drives, or memory), one or more network interfaces 1630 for communicating with external data sources, users, and other system components, and optionally one or more graphics processing units (GPUs) 1640 or other hardware accelerators for executing machine learning model inference and training operations.

The non-transitory computer-readable storage media 1620 store instructions that, when executed by the one or more processors 1610 (or GPUs 1640), cause the computing system to perform the operations described herein. The computing system environment 1600 may further include an operating system, a web server, a database management system, and software frameworks for machine learning model execution (e.g., PyTorch, TensorFlow, ONNX Runtime, or equivalents).

In some embodiments, the computing system environment 1600 is a single computing device. In some embodiments, the computing system environment 1600 is a distributed computing system comprising multiple computing devices communicating over one or more networks. In some embodiments, the computing system environment 1600 includes one or more virtual machines or containerized environments executing on physical or cloud-hosted hardware.

### CONCRETE EXAMPLES

The following non-limiting examples illustrate the operation of the system 100 in representative use cases.

### Example 1 (Post-Storm Residential Assessment)

A roofing service provider selects a county that experienced a severe hailstorm two weeks prior. The system 100 acquires satellite imagery at approximately 15 cm GSD resolution for approximately 50,000 residential structures in the county, retrieves hailstorm event data indicating maximum hail diameters of 1.5 to 2.5 inches across the county, and retrieves building metadata indicating structure ages ranging from 2 to 45 years. The instance segmentation engine 120 identifies approximately 52,000 roof instances (some properties have multiple structures). The image enhancement pipeline 130 applies GAN super-resolution to improve the effective resolution and applies diffusion refinement to approximately 12% of structures where the imagery quality score is below the gating threshold. The feature extraction engine 140 detects structural condition indicators for each structure, finding impact damage indicators on approximately 38% of structures and missing material indicators on approximately 8% of structures. The scoring subsystem 160 computes recommendation scores, with the top 15% of structures receiving scores above 70. The artifact generation subsystem 170 generates hosted digital portals and machine-readable codes for the top-scoring structures. The service provider receives a prioritized map and list in the user interface, and prints leave-behind documents for the highest-priority structures for door-to-door visits.

### Example 2 (Commercial Portfolio Monitoring)

A facility management organization submits a portfolio of 200 commercial structures for ongoing monitoring. The system 100 processes each structure through the full pipeline and establishes a baseline recommendation score. Continuous monitoring is activated. Three months later, a severe windstorm affects a portion of the monitored region. The system 100 detects the weather event trigger, retrieves updated weather data, and re-computes scores for the 45 affected structures using cached imagery and segmentation results. Twelve structures show a score increase exceeding the significance threshold of 15 points. The system 100 generates updated assessment artifacts and sends push notifications to the facility manager with the updated findings.

### Example 3 (Inbound Property Owner Analysis)

A property owner visits a service provider's website and enters their property address. The system 100 performs a real-time or near-real-time single-property analysis, applying the full pipeline from imagery acquisition through artifact generation. Within a target latency of 10 to 60 seconds (depending on cache availability and imagery acquisition time), the system 100 generates a hosted digital portal for the property with an annotated visual representation, the recommendation score, and an interface to the conversational agent module 175 for follow-up questions. The property owner interacts with the conversational agent to understand the findings and schedules an inspection appointment.

### Example 4 (Multi-Resolution Processing)

The system 100 processes a set of structures using imagery from two different providers: one providing nadir imagery at 30 cm GSD and another providing oblique imagery at 10 cm GSD. For structures where only the lower-resolution imagery is available, the GAN enhancement stage 132 applies 2× or 4× super-resolution processing before feature extraction. For structures where the higher-resolution oblique imagery is available, the GAN enhancement stage 132 applies primarily denoising. The feature extraction engine 140 processes both enhanced imagery sets using the same model ensemble, producing structural condition indicators that may be compared or fused. The scoring subsystem 160 may incorporate an imagery quality factor into the weighting scheme, giving slightly lower weight to conditions detected from lower-resolution source imagery unless confirmed by the enhancement pipeline's quality assessment.

### Advantages

The system 100 and methods described herein provide several technical advantages over conventional approaches.

First, the image enhancement pipeline 130 enables reliable structural condition detection from mass-market commodity imagery that would otherwise be insufficiently detailed for automated analysis, thereby expanding the geographic scope and reducing the per-structure cost of automated assessment compared to systems requiring purpose-captured high-resolution imagery.

Second, the multimodal fusion of imagery-derived condition indicators with weather event data, building metadata, and permit-based signals in the scoring subsystem 160 produces recommendation scores that account for contextual factors beyond what is visible in the imagery alone, reducing false positives (e.g., cosmetic marks misidentified as damage) and false negatives (e.g., damage obscured by recent imagery capture conditions but indicated by weather history).

Third, the configurable weighting scheme allows different users to tune the scoring to their specific geographic and operational context without requiring model retraining, providing personalization at the user level while maintaining shared underlying analysis infrastructure.

Fourth, the automatic generation of property-specific engagement artifacts bridges the gap between analytical findings and field operations, reducing manual effort required to translate analysis results into actionable communications.

Fifth, the human review and active learning loop enables continuous improvement of model accuracy over time as reviewer annotations augment the training dataset, creating a positive feedback cycle where increased usage leads to increased accuracy.

Sixth, the temporal comparison capability enables detection of structural condition changes over time by comparing feature representations extracted from imagery captured at different dates, providing change indicators that improve scoring accuracy beyond what single-point-in-time analysis can achieve and enabling proactive identification of structures with deteriorating conditions before the deterioration reaches a critical threshold.

Seventh, the continuous monitoring workflow with trigger-based re-assessment reduces computational cost and latency compared to periodic full-pipeline re-processing of all monitored structures, by selectively re-processing only structures affected by a detected trigger event and reusing cached intermediate results from prior processing stages where the underlying input data has not changed.

Eighth, the end-to-end optimization capability enables the recommendation score objective to propagate back through the processing pipeline to refine upstream feature extraction and image enhancement operations. Unlike conventional systems where feature extraction models are trained for a fixed intermediate representation (e.g., a generic condition assessment), the system 100 enables fine-tuning the entire pipeline from the downstream recommendation outcome, ensuring that the features extracted from imagery are specifically optimized for the particular end-state recommendation that the service provider or property stakeholder requires. This capability enables the system 100 to serve diverse use cases (e.g., maintenance prioritization, financial planning, energy efficiency assessment) from the same underlying multi-modal data inputs by adapting the feature extraction behavior to each use case, representing a technical improvement over systems with frozen intermediate representations that cannot be tailored to downstream objectives.

What is claimed is:

1. A system for automated property structural condition assessment and property-specific engagement artifact generation, the system comprising:
one or more processors; and
one or more non-transitory computer-readable storage media storing instructions that, when executed by the one or more processors, cause the system to perform operations comprising:
(a) receiving, from a plurality of data sources, aerial or satellite imagery depicting a plurality of structures within a geographic region, weather event data characterizing one or more weather events affecting the geographic region, and building metadata describing attributes of the plurality of structures;
(b) for each respective structure of at least a subset of the plurality of structures:
(i) applying one or more image enhancement models to a portion of the aerial or satellite imagery associated with the respective structure to produce enhanced imagery, the enhanced imagery having improved signal quality relative to the received aerial or satellite imagery;
(ii) applying one or more feature extraction models to the enhanced imagery to generate a set of structural condition indicators for the respective structure, each structural condition indicator being associated with a respective confidence value; and
(iii) computing a recommendation score for the respective structure by fusing the set of structural condition indicators with at least a portion of the weather event data and at least a portion of the building metadata according to a weighting scheme; and
(c) for at least a subset of the plurality of structures having recommendation scores satisfying a selection criterion, automatically generating a property-specific engagement artifact comprising at least an annotated visual representation of the respective structure and the respective recommendation score.

2. The system of claim 1, wherein the one or more image enhancement models comprise a generative adversarial network trained to perform at least one of super-resolution processing or denoising on the aerial or satellite imagery.

3. The system of claim 1, wherein the operations further comprise applying an instance segmentation model to the aerial or satellite imagery to identify, for each of a plurality of distinct structural regions within the imagery, a corresponding segmentation mask, and wherein the portion of the aerial or satellite imagery associated with the respective structure is determined based on a segmentation mask corresponding to the respective structure.

4. The system of claim 1, wherein the set of structural condition indicators comprises indicators for a plurality of condition types including two or more of: missing roofing material, cracked roofing material, impact damage, wind-induced displacement, moisture accumulation, biological growth, flashing displacement, or debris accumulation.

5. The system of claim 1, wherein the weighting scheme is configurable by a user through a user interface, the user interface enabling the user to adjust relative influence of at least one of: the weather event data, the building metadata, or one or more of the structural condition indicators on the recommendation score.

6. The system of claim 1, wherein the weather event data comprises, for each of one or more weather events, one or more hazard exposure metrics derived from at least one of: hail event data, wind event data, precipitation data, or temperature cycling data, each hazard exposure metric being associated with a temporal window and a geographic matching parameter.

7. The system of claim 1, wherein computing the recommendation score comprises applying a machine-learned scoring model and a rule-based scoring model to the set of structural condition indicators and combining outputs of the machine-learned scoring model and the rule-based scoring model.

8. The system of claim 1, wherein the operations further comprise processing building permit records associated with respective structures of the plurality of structures to derive permit-based condition signals indicating at least one of: a prior repair event, a damage-related permit filing, or a construction age indicator, and wherein computing the recommendation score further comprises incorporating the permit-based condition signals.

9. The system of claim 1, wherein the operations further comprise, for at least one structure of the plurality of structures, comparing feature representations extracted from imagery of the at least one structure captured at a first time with feature representations extracted from imagery of the at least one structure captured at a second time to generate a temporal change indicator, and wherein the recommendation score for the at least one structure further incorporates the temporal change indicator.

10. The system of claim 1, wherein the property-specific engagement artifact further comprises a machine-readable code that, when captured or accessed by a computing device, directs the computing device to a hosted digital portal displaying the annotated visual representation and one or more recommended actions for the respective structure.

11. A computer-implemented method for assessing structural conditions of a plurality of structures and generating property-specific engagement artifacts, the method comprising:
(a) receiving, by one or more processors, from a plurality of data sources, aerial or satellite imagery depicting a plurality of structures within a geographic region, weather event data characterizing one or more weather events affecting the geographic region, and building metadata describing attributes of the plurality of structures;
(b) for each respective structure of at least a subset of the plurality of structures:
(i) applying, by the one or more processors, one or more image enhancement models to a portion of the aerial or satellite imagery associated with the respective structure to produce enhanced imagery, the enhanced imagery having improved signal quality relative to the received aerial or satellite imagery;
(ii) applying, by the one or more processors, one or more feature extraction models to the enhanced imagery to generate a set of structural condition indicators for the respective structure, each structural condition indicator being associated with a respective confidence value; and
(iii) computing, by the one or more processors, a recommendation score for the respective structure by fusing the set of structural condition indicators with at least a portion of the weather event data and at least a portion of the building metadata according to a weighting scheme; and
(c) for at least a subset of the plurality of structures having recommendation scores satisfying a selection criterion, automatically generating, by the one or more processors, a property-specific engagement artifact comprising at least an annotated visual representation of the respective structure and the respective recommendation score.

12. The method of claim 11, further comprising applying a diffusion-based refinement model to at least a portion of the enhanced imagery, the diffusion-based refinement model being conditioned on at least one environmental parameter associated with the respective structure.

13. The method of claim 11, further comprising, prior to applying the one or more feature extraction models, segmenting individual structural regions from the aerial or satellite imagery using an instance segmentation model trained on a training dataset comprising manually annotated imagery and synthetically generated imagery.

14. The method of claim 11, further comprising routing structures having at least one confidence value below a review threshold to a human review queue, receiving reviewer annotations from a human reviewer via a review interface, and incorporating the reviewer annotations into a training dataset for updating at least one of the one or more image enhancement models or the one or more feature extraction models.

15. The method of claim 11, wherein computing the recommendation score further comprises accessing, for the respective structure, one or more demographic attributes associated with the respective structure and adjusting the recommendation score based at least in part on the one or more demographic attributes.

16. The method of claim 11, further comprising, responsive to detecting a new weather event affecting a previously assessed geographic region, automatically re-computing recommendation scores for structures within an affected area of the geographic region using updated weather event data.

17. The method of claim 11, further comprising selecting, for each respective structure for which an engagement artifact is generated, an artifact format from a plurality of available artifact formats based on at least one of: a user preference, a structure classification, or a delivery channel identifier.

18. A non-transitory computer-readable storage medium storing instructions that, when executed by one or more processors of a computing system, cause the computing system to perform operations comprising:
(a) receiving, from a plurality of data sources, aerial or satellite imagery depicting a plurality of structures within a geographic region, weather event data characterizing one or more weather events affecting the geographic region, and building metadata describing attributes of the plurality of structures;
(b) for each respective structure of at least a subset of the plurality of structures:
(i) applying one or more image enhancement models to a portion of the aerial or satellite imagery associated with the respective structure to produce enhanced imagery, the enhanced imagery having improved signal quality relative to the received aerial or satellite imagery;
(ii) applying one or more feature extraction models to the enhanced imagery to generate a set of structural condition indicators for the respective structure, each structural condition indicator being associated with a respective confidence value; and
(iii) computing a recommendation score for the respective structure by fusing the set of structural condition indicators with at least a portion of the weather event data and at least a portion of the building metadata according to a weighting scheme; and
(c) for at least a subset of the plurality of structures having recommendation scores satisfying a selection criterion, automatically generating a property-specific engagement artifact comprising at least an annotated visual representation of the respective structure and the respective recommendation score.

19. The non-transitory computer-readable storage medium of claim 18, wherein the operations further comprise fine-tuning at least one of the one or more image enhancement models or the one or more feature extraction models using an objective function that is based at least in part on the recommendation score, thereby adapting the at least one model to produce outputs aligned with a target recommendation objective.

20. The non-transitory computer-readable storage medium of claim 18, wherein the operations further comprise, in response to a batch processing request specifying a geographic boundary, concurrently processing a plurality of structures within the geographic boundary and generating respective property-specific engagement artifacts for structures within the geographic boundary satisfying the selection criterion.
